(19) United States
(12) Patent Application Publication
(10) Pub. No.: US 2026/0371448 A1
(43) Pub. Date: Nov. 19, 2026

(54) Transmissive Heater

(71) Applicant: Illinois Tool Works Inc., Glenview, IL (US)

(72) Inventors: Edward Mehall, Geneva, IL (US); Piotr Sliwa, Arlington Heights, IL (US); Fredrik Andersson, Vasteras (SE); Bradley Stecker, Glenview, IL (US)

(21) Appl. No.: 19/670,295

(22) Filed: May 7, 2026

Related U.S. Application Data
(60) Provisional application No. 63/804,857, filed on May 13, 2025.

(51) Int. Cl. H05B 3/28; H05B 3/84

(52) U.S. Cl. CPC H05B 3/28; H05B 3/84; H05B 2203/016; H05B 2203/031; H05B 2203/035

(57) ABSTRACT

A vehicle sensor system includes an antenna array and a heater array positioned in front of the sensor payload to remove snow, ice, or debris. The heater array is designed to operate from a constant voltage source, while still providing multiple heating power levels. This can be achieved through configurations such as stacked heater traces, multi-layer traces on one or more substrates, temperature-dependent materials, or selectable electrical paths. The heater traces are arranged to maintain a consistent geometry so they have minimal impact on the electromagnetic performance of the sensor payload.

### RELATED APPLICATIONS

The present application claims priority to U.S. Provisional Patent Application No. 63/804,857, filed May 13, 2025, and entitled “Transmissive Heater,” which is hereby incorporated by reference in its entirety.

### BACKGROUND

Antenna arrays used in vehicles, including radar systems and other sensors, can experience performance degradation due to the accumulation of snow, ice, or frost on their surfaces. Such buildup obstructs the transmission and reception of electromagnetic signals, reducing the effectiveness and reliability of the systems. Conventional heating solutions may mitigate environmental accumulation but often rely on variable voltage supplies to achieve different heating power levels, adding system complexity and potential inefficiencies. Accordingly, there exists a need for a heater array capable of providing selectable heating power levels while operating from a substantially constant voltage source.

The present disclosure addresses these challenges by providing a heater array positioned above the antenna array, configured to remove snow and ice while enabling different heating power levels using a constant voltage supply.

### SUMMARY

The present disclosure relates generally to a heater array, substantially as illustrated by and described in connection with at least one of the figures, as set forth more completely in the claims.

### DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1a illustrates a vehicle including one or more sensor systems.

FIG. 1b illustrates an assembly view of an example sensor system having a heater system with heater traces arranged to form a heater array.

FIG. 2a illustrates an example heater system with a heater array in accordance with an aspect of the present disclosure.

FIG. 2b illustrates a cross-sectional view of the heater array of FIG. 2a taken along cutline A-A.

FIG. 3a illustrates another example heater system with a heater array in accordance with an aspect of the present disclosure.

FIG. 3b illustrates a cross-sectional view of the heater array of FIG. 3a taken along cutline B-B.

FIG. 4 illustrates a cross-sectional view of another example heater system with a heater array in accordance with an aspect of the present disclosure.

FIG. 5a illustrates another example heater system with a heater array in accordance with an aspect of the present disclosure.

FIG. 5b illustrates a cross-sectional view of the heater array of FIG. 5a taken along cutline C-C.

FIG. 6 illustrates a cross-sectional view of another example heater system with a heater array in accordance with an aspect of the present disclosure.

FIG. 7a illustrates yet another example heater system with a heater array in accordance with an aspect of the present disclosure.

FIG. 7b illustrates a cross-sectional view of the heater array of FIG. 7a taken along cutline D-D.

FIG. 8a illustrates yet another example heater system with a heater array in accordance with an aspect of the present disclosure.

FIG. 8b illustrates a cross-sectional view of the heater array of FIG. 8a taken along cutline E-E.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Disclosed is a heater array for removing snow and ice from an antenna array that can provide different power levels (e.g., amount of heat or heat profile) using a constant voltage.

In one example, a heater system for use with a vehicle sensor comprises: at least one heater substrate; a plurality of heater traces supported by the at least one heater substrate, each heater trace being configured to generate heat in response to application of a voltage; and a plurality of electrical leads configured to selectively energize one or more of the plurality of heater traces while maintaining the voltage constant, wherein the heater system is configured to provide a plurality of different heating power levels by varying a total current draw through selective energization of the plurality of heater traces.

In some examples, at least two of the plurality of heater traces are arranged in a stacked configuration in a thickness direction.

In some examples, the at least two heater traces overlap in the thickness direction while maintaining a substantially constant lateral geometry.

In some examples, at least two of the plurality of heater traces are disposed on opposite sides of a same heater substrate.

In some examples, at least two of the plurality of heater traces are disposed on different heater substrates that are stacked.

In some examples, at least two of the plurality of heater traces are embedded within different layers of a multilayer heater substrate.

In some examples, the plurality of heater traces includes a first heater trace having a first width and a second heater trace having a second width different from the first width.

In some examples, the plurality of electrical leads includes a separate pair of leads associated with each heater trace.

In some examples, the plurality of electrical leads includes a common ground lead and a plurality of positive leads corresponding to respective heater traces.

In some examples, the heater traces are configured to maintain a substantially constant electromagnetic profile during operation.

In some examples, the at least one heater substrate is a common heater substrate and the plurality of heater traces comprises two heater traces that are disposed on opposite sides of the common heater substrate.

In another example, a heater system for use with a vehicle sensor comprises: a heater trace supported by a substrate and configured to generate heat in response to application of a voltage; a first electrical path configured to supply the voltage to the heater trace; a second electrical path configured to supply the voltage to the heater trace through a resistor connected in series with the heater trace; and a switching element configured to selectively connect the heater trace to the first electrical path or the second electrical path, wherein the heater system is configured to provide different heating power levels based on selection of the first electrical path or the second electrical path, while maintaining the voltage constant.

In some examples, the resistor is configured to reduce current through the heater trace when the second electrical path is selected.

In some examples, the switching element comprises a solid-state switching device.

In some examples, the switching element is configured to selectively connect the heater trace to only one of the first electrical path or the second electrical path at a given time.

In some examples, the heater system further comprises a common negative lead shared by the first electrical path and the second electrical path.

In some examples, the heater trace maintains a substantially constant geometry to limit changes in electromagnetic interaction with a sensor payload.

In some examples, the heater system is configured to operate from a nominal vehicle voltage without varying the applied voltage to control heating output.

In some examples, the heater system further comprises a control circuit configured to actuate the switching element based on at least one of a temperature condition or a timing condition.

In some examples, the resistor is selected to provide a reduced heating power level relative to the first electrical path.

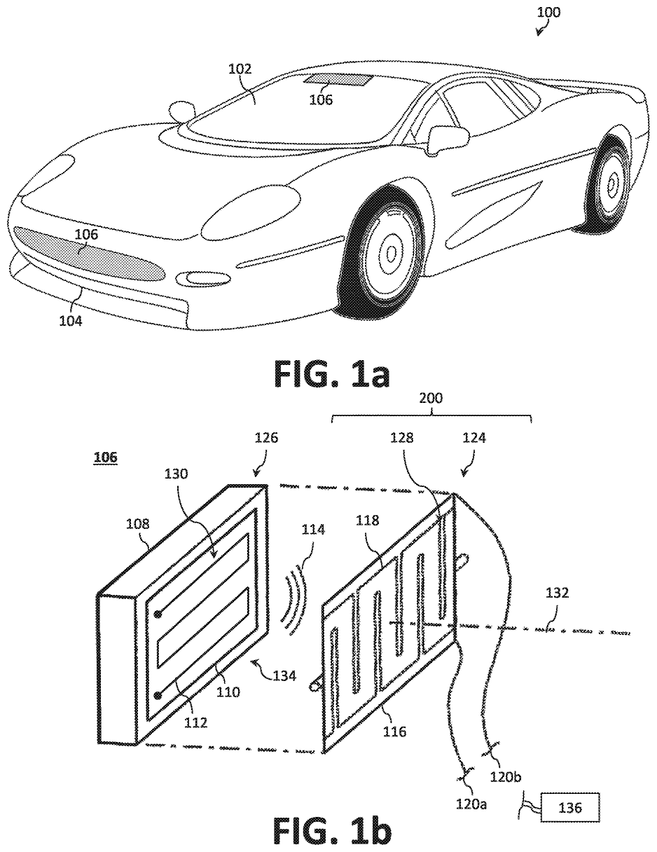

FIG. 1a illustrates a vehicle 100 having one or more sensor systems 106. As shown, the vehicle 100 includes a windshield 102, a bumper 104, and one or more sensor systems 106 positioned in or on the windshield 102 and/or the bumper 104. Each sensor system 106 comprises a sensor payload 126 configured to monitor aspects of the environment surrounding the vehicle 100, such as obstacles, distances, traffic signs, and markings. In some examples, the sensor payload 126 includes an antenna array 130 formed from a plurality of antenna traces 112 and/or other sensors, such as vision-based systems, infrared sensors, LiDAR components, or ultrasonic sensors.

FIG. 1b illustrates an assembly view of an example sensor system 106, including the sensor payload 126, the plurality of antenna traces 112 forming the antenna array 130, and a heater system 200. The heater system 200 includes a heater assembly 124 having a plurality of heater traces 118 forming a heater array 128. The heater assembly 124, together with a heater substrate 116, may be formed as a heater laminate. The heater laminate may be implemented as a discrete structure or as part of a layered assembly including additional functional or protective layers.

The sensor payload 126 is configured to exchange electrical signals with a sensor interface circuit, which in turn communicates with a vehicular computer. The vehicular computer manages vehicle control tasks such as steering, braking, and engine or motor acceleration. Additionally, the sensor payload 126 may communicate with vehicle cockpit display systems to provide information to occupants.

With reference to FIG. 1b, the antenna traces 112 are printed onto or otherwise adhered to an antenna substrate 110, such as a printed circuit board (PCB) or other dielectric support structure, thereby increasing the structural integrity and stability of the antenna array 130. The antenna substrate 110, together with the antenna array 130, is attached to or enclosed within a sensor housing 108, which may be formed from a rigid material such as a molded plastic or composite. The sensor housing 108 may include mounting elements configured to secure the sensor payload 126 in a predetermined orientation relative to the vehicle 100 and to provide environmental sealing against moisture, debris, and other contaminants.

During operation, the sensor payload 126 includes a window area 134 through which it transmits and/or receives sensor energy 114 relative to the vehicle 100 along a sensing axis 132. The sensor energy 114 may include electromagnetic signals corresponding to one or more sensing modalities. Front-facing sensor payloads 126 may provide a 77-gigahertz long-range radar system with a sensing capability of approximately 1 to 120 meters. Additionally, or alternatively, the front-facing sensor payloads 126 may include far-infrared imaging sensors (approximately 0.2 to 80 meters), visible-light video sensors or LiDAR systems (up to approximately 280 meters), short-range radar (24 GHz, approximately 0.2 to 20 meters), and ultrasonic sensors (approximately 0.2 to 1.5 meters). Side-mounted sensor systems 106 may also provide short-range radar and ultrasonic sensing.

To reduce electromagnetic interference with the antenna array 130 and other sensing components, the heater traces 118 are arranged in a high-frequency transparent grid or mesh pattern. This configuration enables the heater traces 118 to remain effectively transparent to electromagnetic signals, thereby minimizing reflection, scattering, and attenuation of the sensor energy 114.

If the window area 134 becomes obstructed by snow, ice, or debris, the sensor energy 114 may be partially or fully blocked, thereby reducing the effectiveness of the sensor payload 126. The heater system 200 is positioned over the sensor payload 126, with the heater assembly 124 disposed over the window area 134 and between the window area 134 and the external environment. This placement enables the heater system 200 to mitigate accumulation of snow, ice, or other contaminants.

The heater system 200 includes the heater assembly 124, which comprises a plurality of heater traces 118 forming the heater array 128. The heater traces 118 may be separated from the antenna array 130 or other sensing elements by a small air gap or may be embedded within a radome material of the vehicle 100. This configuration enables effective heat transfer while avoiding direct interference with the antenna array 130. The heater substrate 116 is selected to have dielectric properties that match or closely approximate those of surrounding materials to reduce impedance mismatches. Additionally, the structural and material characteristics of the heater traces 118 are selected to avoid resonances within an operational frequency band of the antenna array 130. In some examples, frequency-selective surfaces (FSS) may be incorporated to enhance electromagnetic transparency while maintaining thermal performance.

In one example, the heater traces 118 are embedded within or printed on the heater substrate 116, which may be formed of a low-loss dielectric material such as polyimide, polyethylene terephthalate (PET), or glass with a suitable coating. These materials reduce signal degradation due to their low electromagnetic loss properties. The heater traces 118, configured as conductive elements, generate heat when an electrical current is applied. The heater substrate 116 may be thin, transmissively transparent, and optically clear, and may also be water-resistant or treated for water repellency, thereby providing environmental protection for the sensor payload 126. Additional transmissive protective housings may be positioned along a propagation path of the sensor energy 114.

The heater array 128 can be powered by an electrical system of the vehicle 100, with voltage and current levels selected to provide effective heating without overloading the system. Integrated temperature sensors may monitor surface temperature and dynamically adjust power to prevent overheating and improve energy efficiency. A control system may use pulse-width modulation (PWM) to regulate heating. The heater assembly 124 may receive electrical power through leads 120a (positive lead) and 120b (negative/ground lead) to heat the assembly and melt accumulated sleet, ice, or snow that could obstruct transmission or reception of the sensor energy 114. In one embodiment, the heater assembly 124 operates at approximately 15 to 20 watts.

Power may be supplied to the leads 120a and 120b selectively via a power control circuit or other switching element 136, such as a solid-state switching device (e.g., a transistor), configured to switch a DC voltage based on temperature sensor readings, periodic intervals, processor control, etc. In implementations involving infrared sensors, heating may be interleaved with sensing intervals to reduce interference. The DC voltage may be floating or referenced to operating voltages of the sensor payload 126, such as those used by radiofrequency modulators and demodulation amplifiers in radar systems.

The heater traces 118 may be fabricated from thin conductive materials such as indium tin oxide (ITO), silver nanowires, or fine metallic grids. These materials provide transparency to electromagnetic waves while maintaining sufficient resistance for heating. To promote uniform heating, the heater traces 118 may be designed with substantially consistent resistance along their lengths, thereby reducing localized thermal variations. The heater array 128 may include multiple independent heating zones that can be selectively activated based on detected snow or ice accumulation, thereby improving energy efficiency.

In some examples, the heater traces 118 of the heater assembly 124 are formed on a surface of the heater substrate 116 using a positive temperature coefficient (PTC) material, which exhibits a positive temperature coefficient of resistance. Such a material causes electrical conductivity to vary with temperature, with increased current flow at lower temperatures and decreased current flow at higher temperatures. This property enables self-regulation of temperature when a substantially constant voltage is applied across the PTC material. In one embodiment, the PTC material may comprise an ethylene vinyl acetate copolymer resin with carbon black added.

The PTC material may be processed, including rolling, until a desired sheet resistivity is achieved. The heater assembly 124 may include interdigitated electrodes configured to apply voltage across the PTC material, thereby promoting current flow generally along a plane of the PTC material. The electrodes may be formed, for example, by screen printing conductive metallic inks, vapor deposition of conductive materials, application as a thin decal, or etching from an adhered film using integrated circuit fabrication techniques.

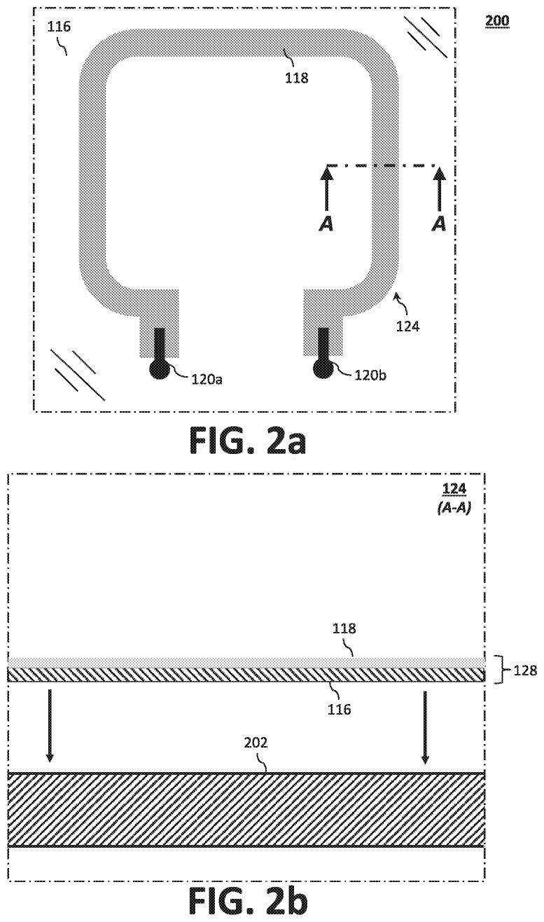

FIG. 2a illustrates an example heater system 200 with a heater array 128 in accordance with an aspect of the present disclosure, and FIG. 2b illustrates a cross-sectional view of the heater array 128 of FIG. 2a taken along cutline A-A. In this example, the heater system 200 includes a single heater array 128. The heater array 128 comprises at least one heater trace 118 configured as a conductive element that heats the antenna array 130, or a portion thereof.

The electromagnetic impact of the heater trace 118 is determined primarily by the surface area and geometry of the heater trace 118. Accordingly, the heater trace 118 is configured such that its geometry remains substantially constant to avoid changes in electromagnetic performance. This consideration is particularly relevant when the heater array 128 is positioned above an antenna array 130, where the electromagnetic field associated with operation of the antenna array 130 extends through the heater array 128. In some examples, the heater array 128 is installed over a glare shield 202 associated with the sensor payload 126 or radome. The heater trace 118 is therefore designed to provide heating functionality while operating at a substantially constant voltage and maintaining a controlled and minimal impact on the electromagnetic field.

In some examples, the heater array 128 is configured to operate with a substantially constant voltage supply. Many vehicles operate at a nominal voltage, such as approximately 12 V in internal combustion engine vehicles, although the actual voltage may vary depending on operating conditions. Electric vehicles may include higher-voltage battery systems, with power converted to lower voltages for auxiliary systems such as the heater system 200.

Operation at a substantially constant voltage allows the heater system 200 to be powered directly from the nominal vehicle voltage without requiring additional voltage conversion for heat control. During operation, the voltage is selectively applied to leads 120a and 120b of the heater trace 118. Supplying this substantially constant voltage to the leads 120a, 120b causes resistive heating, while interrupting the voltage allows the heater trace 118 to cool. Heat output from the heater system 200 may be controlled by selectively switching the power, for example using pulse-width modulation.

Although the example heater system 200 of FIGS. 2a and 2b illustrates a single heater array 128 with a single heater trace 118, additional heater arrays 128 and/or heater traces 118 may be provided to adjust or tailor the heat output while maintaining operation at a substantially constant voltage. For example, a plurality of heater arrays 128 with heater traces 118 having different shapes, sizes, and electrical resistances may be used to tailor the heat distribution and thermal profile of the heater system 200.

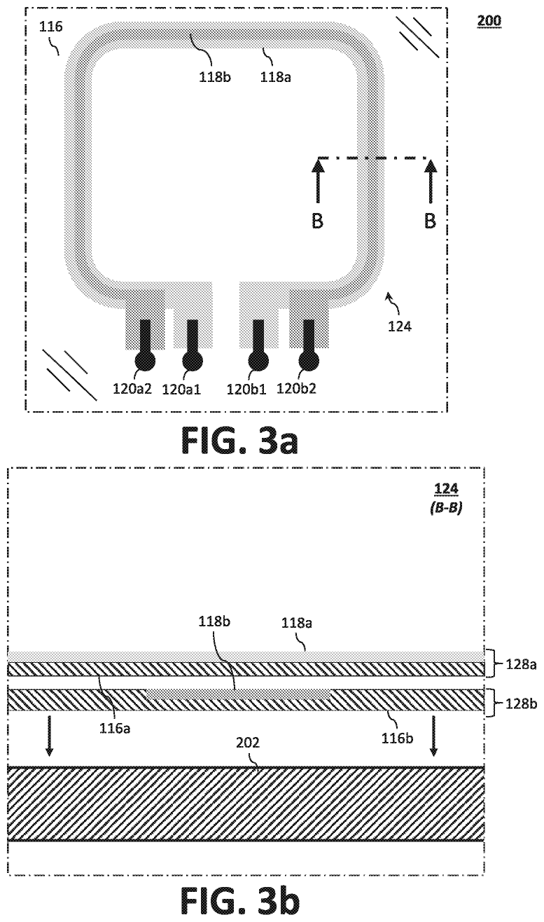

FIGS. 3a and 3b illustrate another example heater system 200 with multiple heater arrays 128 in accordance with an aspect of the present disclosure, with FIG. 3b providing a cross-sectional view taken along cutline B-B. In this example, the heater system 200 includes a first heater array 128a and a second heater array 128b. Each of the first heater array 128a and the second heater array 128b is configured as a separate heater laminate, each including a corresponding heater assembly 124, heater substrate 116, and at least one heater trace 118a, 118b forming the respective heater arrays 128a, 128b.

The heater system 200, via the first heater array 128a and the second heater array 128b, is configured to provide multiple heating power levels while still operating at a substantially constant voltage. In particular, the configuration enables an increase in current draw, and thus heating power, without materially altering the electromagnetic characteristics of the heater array 128 as perceived by the antenna array 130. This objective is achieved by introducing additional conductive material in the form of a separate heater array, rather than increasing the width or geometry of a single heater trace.

As best illustrated in FIG. 3a, the first heater array 128a and the second heater array 128b are independently controllable, and each heater array includes its own pair of electrical leads. Specifically, the first heater array 128a includes a positive lead 120a1 and a negative lead 120b1, and the second heater array 128b includes a positive lead 120a2 and a negative lead 120b2. This independent control enables selective activation of the heater arrays 128a, 128b such that, depending on the desired heating level or environmental condition, one heater array may be activated while the other remains inactive, both heater arrays may be activated simultaneously to provide increased heating output, or both may remain inactive.

With reference to the cross-sectional view of FIG. 3b, the first heater array 128a and the second heater array 128b are arranged in a stacked configuration, one above the other, and collectively positioned over the glare shield 202, which may be part of or associated with the sensor payload 126 or radome structure. In this configuration, multiple heater traces 118a, 118b are positioned above each other (e.g., in a stacked configuration) without increasing the effective width of any individual heater trace 118a, 118b. In the illustrated example, the first heater trace 118a associated with the first heater array 128a is wider than the second heater trace 118b associated with the second heater array 128b. While the wider trace (first trace 118a) is shown as being on top of the narrower trace (second trace 118b), the stacking order may be reversed or otherwise modified depending on design considerations.

By maintaining the overall lateral width of the heater traces 118a, 118b consistent with simpler designs (such as the single-trace configuration of FIGS. 2a and 2b), the surface area distribution of conductive material of the traces 118a, 118b remains substantially unchanged in the lateral direction. Although the stacked configuration increases the overall thickness of conductive material (again, as compared to the heater system 200 of FIGS. 2a and 2b, for example), each heater trace 118 is sufficiently thin such that the cumulative increase in thickness has only a negligible effect on the electromagnetic field associated with operation of the sensor payload 126/antenna array 130. As a result, the heater system 200 is capable of providing increased heating performance while maintaining minimal electromagnetic interference.

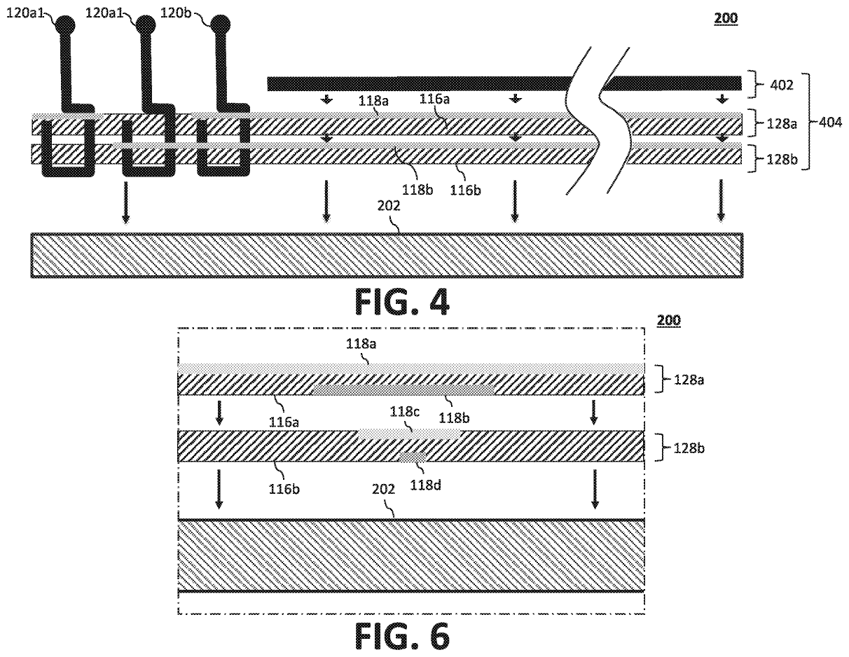

FIG. 4 illustrates a cross-sectional view of another example heater system 200 with multiple heater arrays 128a and 128b arranged in a stacked configuration similar to that described in connection with FIGS. 3a and 3b. In this example, however, a common ground configuration is implemented. Specifically, instead of providing separate negative leads for each heater array, a single negative lead 120b is shared between the first heater array 128a and the second heater array 128b, while separate positive leads 120a1 and 120a2 are maintained to allow for independent control of the separate first heater array 128a and the second heater array 128b.

In this configuration, the heater array 128 includes termination connections for the shared negative lead 120b and for each of the separate positive leads 120a1 and 120a2. These connections extend through one or more of the heater laminates to electrically couple heater traces 118 across the laminates, thereby establishing a common reference potential. The use of a common ground connection provided by the single negative lead 120b reduces material usage, simplifies electrical routing, and may reduce manufacturing complexity. This configuration is achieved by connecting the heater traces 118 through the laminates so that they share a common reference potential while still enabling multiple heating configurations. In this

Additionally, in the example of FIG. 4, an anti-glare laminate 402 is positioned over the first heater array 128a. The anti-glare laminate 402, together with the first heater array 128a and the second heater array 128b, forms a multi-functional composite laminate structure 404. The anti-glare laminate 402 is configured to improve sensor performance by scattering, or diffusing, incident light that could impact reliable operation, thereby reducing glare and improving the performance and reliability of the sensor payload 126. The anti-glare laminate 402 may be used in combination with any of the heater system configurations described herein.

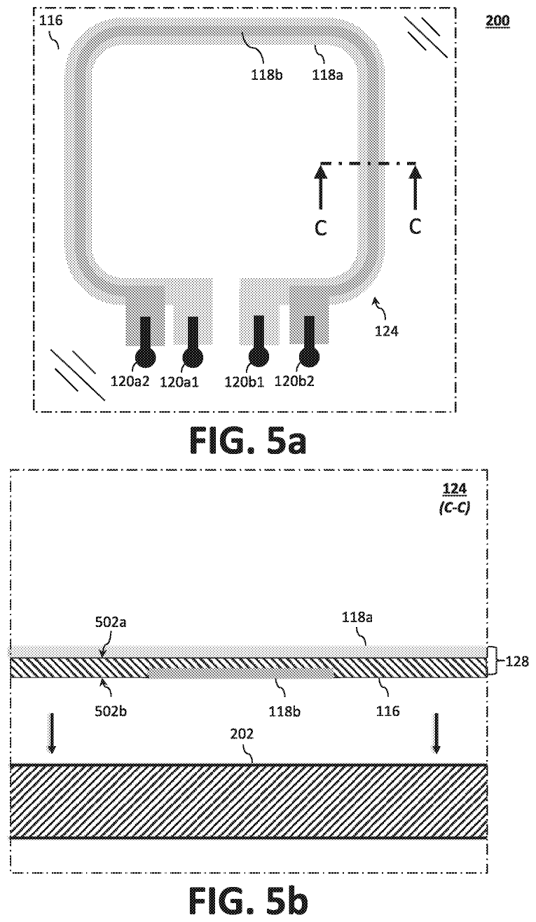

FIGS. 5a and 5b illustrate another example heater system 200 in which multiple heater traces 118 are implemented within a single heater laminate. FIG. 5b provides a cross-sectional view of the multiple heater trace 118 of FIG. 5a taken along cutline C-C. In this configuration, the heater array 128 includes a first heater trace 118a and a second heater trace 118b, both supported by a single heater substrate 116.

Unlike the stacked laminate approach described in FIGS. 3 and 4, the first heater trace 118a and the second heater trace 118b are formed on opposite sides of the same heater substrate 116. Specifically, the first heater trace 118a is formed on a first side 502a of the heater substrate 116, and the second heater trace 118b is formed on a second side 502b of the heater substrate 116. Each heater trace 118a, 118b may be formed by printing, deposition, or other suitable fabrication techniques.

This configuration enables increased current draw and heating capability by effectively stacking conductive elements in the thickness direction while maintaining a single laminate structure. As with other configurations, the goal is to increase heating power while maintaining minimal impact on the electromagnetic field. By placing the heater traces 118a, 118b on opposite sides of the substrate 116. In one example, a first heater trace 118 is formed on a first side 502a of the heater substrate 116, and a second heater trace 118 is formed on a second, opposite side 504b of the heater substrate 116. This solution includes placing multiple heater traces 118a, 118b above each other. The traces are effectively aligned in a stacked configuration without increasing the effective width of the heater traces. As a result, the electromagnetic transparency characteristics remain substantially unchanged.

FIG. 6 illustrates a cross-sectional view of a further example heater system 200 that combines features of multiple previous configurations. In this example, multiple heater laminates are stacked, including a first heater array 128a and a second heater array 128b, and each laminate includes multiple heater traces formed on one or both sides of the respective first and second heater substrates 116a, 116b. For example, the system may include a first heater trace 118a and a second heater trace 118b associated with the first heater array 128a, and a third heater trace 118c and a fourth heater trace 118d associated with the second heater array 128b.

In this configuration, each heater array 128a, 128b may be implemented as a double-sided laminate, and the laminates are stacked to form a multi-layer structure. This arrangement enables a greater number of independently controllable heater traces, thereby increasing the number of possible heating configurations. By selectively activating different combinations of heater traces 118a, 118b, 118c, 118d across the multiple laminates, the heater system 200 can provide a wide range of heating power levels while continuing to operate at a substantially constant voltage.

Despite the increased number of conductive elements, the heater traces are arranged such that their lateral geometry remains controlled and consistent, thereby maintaining a predictable and minimal impact on the electromagnetic field associated with the sensor payload 126.

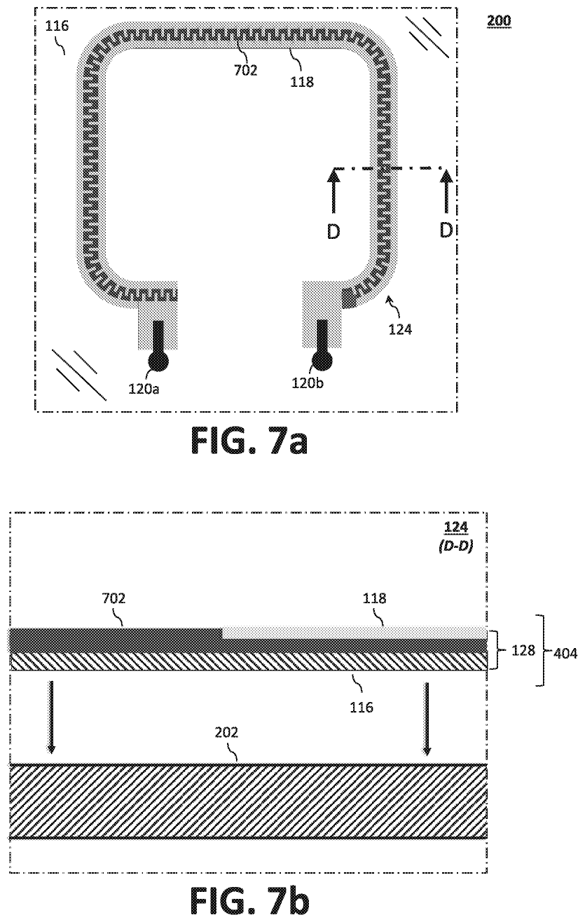

FIGS. 7a and 7b illustrate another example heater system 200 configured to provide variable heating performance without adding additional heater traces or increasing structural complexity through stacking. FIG. 7b provides a cross-sectional view taken along cutline D-D. In this configuration, a positive temperature coefficient (PTC) layer 702 is incorporated in association with a heater trace 118.

The heater trace 118 is printed on, embedded in, or otherwise formed in conjunction with the PTC layer 702 such that the electrical conductivity of the heater trace 118 varies as a function of temperature. As the temperature of the heater trace 118 and surrounding environment changes, the resistance of the PTC layer 702 correspondingly changes. At lower temperatures, the resistance is lower, allowing increased current flow and higher heating output. At higher temperatures, the resistance increases, thereby reducing current flow and limiting further heating.

This behavior enables self-regulation of heating performance while maintaining operation at a substantially constant voltage. Additionally, the PTC layer 702 is configured such that it does not extend beyond the surface defined by the baseline geometry of the heater trace 118. By maintaining this geometric constraint, the heater system 200 avoids introducing additional conductive surface area that could negatively impact the electromagnetic field.

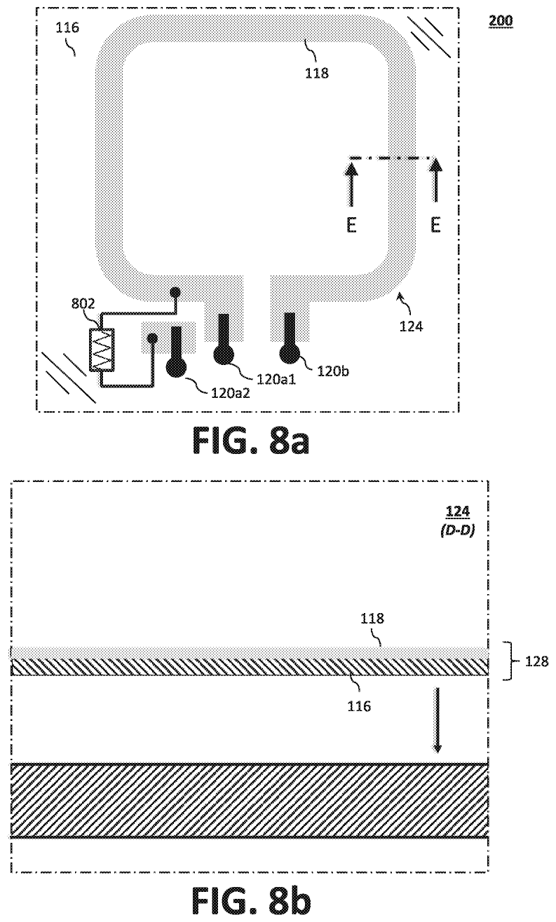

FIGS. 8a and 8b illustrate another example heater system 200 configured to provide multiple heating power levels without the use of stacked heater traces or PTC materials. FIG. 8b provides a cross-sectional view taken along cutline E-E. In this configuration, the heater array 128 includes a single heater trace 118 with multiple electrical terminals.

Specifically, the heater trace 118 is connected to a common negative lead 120b and to multiple positive leads, including a first positive lead 120a1 and a second positive lead 120a2. The multiple positive leads enable selective energization of the heater trace 118 through different electrical paths.

In one example, when the heater trace 118 is energized via the first positive lead 120a1, the heater trace operates at a baseline current level corresponding to direct application of the supply voltage. When the heater trace 118 is energized via the second positive lead 120a2, a resistor 802 connected in series with the heater trace 118 is included in the current path. The resistor 802 reduces the current flowing through the heater trace 118 by dissipating a portion of the electrical energy, thereby resulting in a reduced heating power level.

In some embodiments, the resistor 802 connected in series with the heater trace 118 is selected to provide a controlled reduction in current flow while maintaining operation at a substantially constant supply voltage, such as a nominal vehicle voltage (e.g., approximately 12 V). In some examples, the resistor 802 is a variable resistor where the resistance value can be adjusted in real time or near real time. For example, the resistance value of the resistor 802, when a variable resistor, can be controlled by the power control circuit or other switching element 136.

The resistance value of the resistor 802 may be selected relative to a resistance of the heater trace 118 to establish desired discrete heating power levels. For example, where the heater trace 118 exhibits an effective resistance on the order of approximately 7 Ω to 10 Ω during operation, the resistor 802 may be implemented with a resistance in a range of approximately 1 Ω to 15 Ω. Lower resistance values, such as approximately 1 Ω to 3 Ω, may provide a relatively modest reduction in heating power suitable for maintaining de-icing conditions after initial ice removal. Intermediate resistance values, such as approximately 3 Ω to 8 Ω, may provide a moderate reduction in heating output suitable for energy-saving operation while still preventing re-accumulation of frost or condensation. Higher resistance values, such as approximately 8 Ω to 15 Ω, may provide a substantially reduced heating level for low-power maintenance or standby operation. In each case, the resistor 802 reduces current through the heater trace 118 by increasing total series resistance, thereby reducing power dissipation in the heater trace 118 while maintaining a substantially constant applied voltage and without modifying the geometry of the heater trace 118.

This approach enables multiple heating levels while maintaining the same heater trace geometry and without introducing additional conductive structures that could affect electromagnetic performance. As a result, the heater system 200 maintains minimal impact on the electromagnetic field while providing flexible and controllable heating functionality.

It should be appreciated that the various configurations of the heater system 200 described in connection with the various figures herein are not mutually exclusive and may be selectively combined, modified, or otherwise integrated to achieve a desired thermal, electrical, and electromagnetic performance profile. For example, features associated with single-trace heater arrays, multi-laminate stacked heater arrays, dual-sided heater trace configurations, common ground arrangements, positive temperature coefficient (PTC) materials, and multi-terminal control schemes may be used individually or in any suitable combination.

In this manner, a heater system 200 may be tailored to meet specific design objectives, including desired heating power levels, spatial heat distribution, power consumption constraints, manufacturing considerations, and compatibility with the electromagnetic operating characteristics of the sensor payload 126. Such combinations may be implemented while maintaining operation at a substantially constant voltage and while preserving the controlled geometry and electromagnetic transparency of the heater traces 118, thereby ensuring reliable sensor performance across a range of environmental conditions.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A heater system for use with a vehicle sensor, comprising:
at least one heater substrate;
a plurality of heater traces supported by the at least one heater substrate, each heater trace being configured to generate heat in response to application of a voltage; and
a plurality of electrical leads configured to selectively energize one or more of the plurality of heater traces while maintaining the voltage constant,
wherein the heater system is configured to provide a plurality of different heating power levels by varying a total current draw through selective energization of the plurality of heater traces.

2. The heater system of claim 1, wherein at least two of the plurality of heater traces are arranged in a stacked configuration in a thickness direction.

3. The heater system of claim 2, wherein the at least two heater traces overlap in the thickness direction while maintaining a substantially constant lateral geometry.

4. The heater system of claim 1, wherein at least two of the plurality of heater traces are disposed on opposite sides of a same heater substrate.

5. The heater system of claim 1, wherein at least two of the plurality of heater traces are disposed on different heater substrates that are stacked.

6. The heater system of claim 1, wherein at least two of the plurality of heater traces are embedded within different layers of a multilayer heater substrate.

7. The heater system of claim 1, wherein the plurality of heater traces includes a first heater trace having a first width and a second heater trace having a second width different from the first width.

8. The heater system of claim 1, wherein the plurality of electrical leads includes a separate pair of leads associated with each heater trace.

9. The heater system of claim 1, wherein the plurality of electrical leads includes a common ground lead and a plurality of positive leads corresponding to respective heater traces.

10. The heater system of claim 1, wherein the heater traces are configured to maintain a substantially constant electromagnetic profile during operation.

11. The heater system of claim 1, wherein the at least one heater substrate is a common heater substrate and the plurality of heater traces comprises two heater traces that are disposed on opposite sides of the common heater substrate.

12. A heater system for use with a vehicle sensor, comprising:
a heater trace supported by a substrate and configured to generate heat in response to application of a voltage;
a first electrical path configured to supply the voltage to the heater trace;
a second electrical path configured to supply the voltage to the heater trace through a resistor connected in series with the heater trace; and
a switching element configured to selectively connect the heater trace to the first electrical path or the second electrical path,
wherein the heater system is configured to provide different heating power levels based on selection of the first electrical path or the second electrical path, while maintaining the voltage constant.

13. The heater system of claim 12, wherein the resistor is configured to reduce current through the heater trace when the second electrical path is selected.

14. The heater system of claim 12, wherein the switching element comprises a solid-state switching device.

15. The heater system of claim 12, wherein the switching element is configured to selectively connect the heater trace to only one of the first electrical path or the second electrical path at a given time.

16. The heater system of claim 12, further comprising a common negative lead shared by the first electrical path and the second electrical path.

17. The heater system of claim 12, wherein the heater trace maintains a substantially constant geometry to limit changes in electromagnetic interaction with a sensor payload.

18. The heater system of claim 12, wherein the heater system is configured to operate from a nominal vehicle voltage without varying the applied voltage to control heating output.

19. The heater system of claim 12, further comprising a control circuit configured to actuate the switching element based on at least one of a temperature condition or a timing condition.

20. The heater system of claim 12, wherein the resistor is selected to provide a reduced heating power level relative to the first electrical path.
